(19) United States
(12) Patent Application Publication
(10) Pub. No.: US 2020/0275620 A1
(43) Pub. Date: Sep. 3, 2020

(54) A PLANT CULTIVATION SYSTEM USING HUMIDIFIER

(71) Applicant: Mankaew MUANCHART, Muang Surin (TH)

(72) Inventor: Mankaew MUANCHART, Muang Surin (TH)

(21) Appl. No.: 16/753,743

(22) PCT Filed: Mar. 2, 2018
(86) PCT No.: PCT/TH2018/000008

§ 371 Date: Apr. 3, 2020

(30) Foreign Application Priority Data
Oct. 4, 2017 (TH) 1701005959

(51) Int. Cl. A01G 27/00; A01G 18/00; A01G 31/02

(52) U.S. Cl. CPC A01G 27/003; A01G 31/02; A01G 18/00

(57) ABSTRACT

According to aspect of the present invention there is provided the humidifier cultivation and process comprising:

Humidifier system and process of the humidity cultivation such that develops the humidification process in the cultivation system, it can be used to produce humidity, such as water, solution, vapor, gas solution, mist etc. That creates humidity into the system and recycles it. The system automatically controls the increase and decrease of the solution. Humidity generator and humidifiers comprising ultrasonic humidifier that determines the size of the atomize mist size is 2-8 microns.

### CROSS-REFERENCE TO RELATED APPLICATIONS

This application is a U.S. National Stage entry of PCT Application No: PCT/TH2018/000008 filed Mar. 2, 2018, which claims priority to Thai Patent Application No. 1701005959, filed Oct. 4, 2017, the contents of which are incorporated herein by reference.

### TECHNICAL FIELD

The present invention relates to agriculture and engineering, devices and method, in particular humidifier cultivation and process.

### BACKGROUND

Humidity is an important factor for cultivating all kinds of plants and every step in the cultivation that is in the area of the trunk and leaves plant. When the humidity in the air is high, the plant will lose dehydration. And when the humidity is decreased in the air, the plants will dehydrate quicker and quickly lose water in the plant. The roots of the plant will grow well and tilt in the area with water or humidity. In addition, each plant requires different humidity. Mushroom and moss is a plant that needs humidity all the time, so the system has to develop a humidifier to help plant grow.

WIPO Publication No. 204762524 describes the automation system to control humidity, temperature, carbon dioxide and ammonia gas that is suitable for mushroom cultivation. The monitoring sensor and ultrasonic humidifiers can replace the labor and worker in the cultivation industry. But the patent is only suitable for mushrooms. That is not suitable for other crops.

WIPO No. CN204350743 describes the invention of equipment and the processes to control environment in the closed system which the humidity is increased by spraying water through the closed system. This patent does not specify the importance and characteristics of the humidifier. They only focus on the overall system of closed plant cultivation.

WIPO Publication No. 1020020068980 describes the process of plant cultivation by using the ultrasonic humidifier. The mist increases humidity at the pot area by spraying mist from the top of the plant. And the humidifier also placed below the bottom of the pot.

The previous invention is to add humidity to the cultivation system and does not remove any water or solution that releases into the recycle system. So that cause the waste of resources and lose energy in industry. Recycling is also a way to preserve the environment.

The humidity is a major problem in cultivation. That is a short-lived fan. Because the fan is used to disperse the humidity that usually stick humid. So the weight of the propeller increased by the number of used hours. Finally the fan stopped working and collapsed. The problem can be solved by using a waterproof fan. It can increase the use life, but it is still collapsed. Or to switch to a cheap fan that can be replaced at any time. The problem can be solved by using on-off fan timer for cleaning and maintenance periodically. This method is very difficult to use in the industry and employs more people for the maintenance.

### SUMMARY OF THE INVENTION

According to the present invention there is provided the humidifier cultivation and process comprising;

The apparatus develops a humidifier system for cultivation by developing recycled resources and solving problems. Short-lived fan or no fan required for this method. This method also applies to a variety of crops, and is not specific to any kind of plants. The invention uses a blower with a special feature instead of a fan. The invention technique is to use a blower instead of a general fan. The fan has a pressure less than 1000 mnH2O. The blower have a pressure 1000 mmH2O up to 10 mH2O which is higher than the fan pressure. The process of carrying the solution vapor from the humidifier back into the system and to create a special hose is to send the solution and/or solution vapor. To weld the equipment in some route reduce the blower operation and remove the condensed solution from the blower release out of the blower.

### BRIEF DESCRIPTION OF THE DRAWINGS

An embodiment, incorporating all aspects of the invention, described by way of example only with reference to the accompanying drawing in which

FIG. 1 is block diagram of the process of humidity for cultivation in accordance with an embodiment of the process.

FIG. 2 is block diagram show that the system of humidifier apparatus.

### DETAILED DESCRIPTION

According to cultivation in the present invention refers to the cropping inside the growing chamber (5). The growing chamber (5) has a cavity with entrance of atomize mist and/or solution at least one passage and has plants or roots or both of them.

Definition of humidifier in the present invention refers to any device that creates or gives humidity to the system. The internal components work together by connecting at least one the passages of the atomize mist and/or solution at least four components. That are including of storage tank (1), humidifier (3), growing chamber (5) and drain tank (7) which welded together like close path.

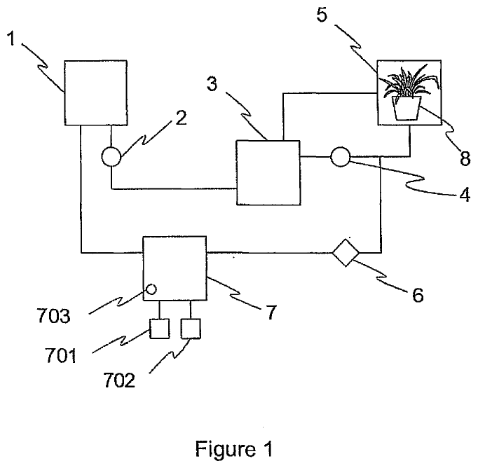

The process of humidity for cultivation describe as FIG. 1 which consists of the solution in the storage tank (1) flows through the pump (2) to the humidifier (3) and the solution volatile to atomize mist and enter into the blower (4). The blower (4) sucks the atomize mist and blows mist through the passage or, in the present invention that the passage is two pipes. The first pipe is connected to the growing chamber (5) with the plant (8). So the part of plant (8) can be located either in the plant (8), whereas the plant (8) is the growing chamber (5) with trunk and/or some part of the plant (8) as well. When the atomize mist gives the humidity in the growing chamber (5), the condensation of atomize mist becomes liquid. The liquid flows through the pipe back into the humidifier (3) again. So the recycle of solution occur.

The second pipe of the blower (4) is connected to the drain tank (7) through a special design pipe (6) that look like crap and hole. It serves to keep the atomize mist and some of atomize mist. So the atomize mist flows through the growing chamber (5) and stick with an electronic blower. It causes damage and collapses in the end. When the blower uses water-resistant characteristics, it cannot be prevented all of water. The sticked atomize mist condense to solution that stick to the blower. So the weight of blowers increase and need more power to rotate. Then the inner components burn and eventually collapse. Hence, there creates a path or a passage or pipe for carrying the solution and the specific solution to the drain tank (7). The drain tank (7) act as the solution storage that limit the volume of solution. When the solution and atomize mist enter the drain tank (7), they accumulate to the required level. So that the switch (701) and (702) transmit signal to drain the solution, the solution level in the drain tank (7) is the maximum level. The switch (701) sends the signal to the pump (703) that carries the solution in pipe through the storage tank (1) again. As resulting, the recycle of the atomize mist and the solution is recycled back. And when the solution level of the drain tank (7) decreases to the lowest level, the switch (702) transmit the signal to the pump (703) to stop working.

Special design pipe (6) has many designation, such as letter U, letter J, letter W and to make cruel like hole at least 1 hole. That is to accumulate some of atomize mist and some of solution. By constructing the specific pipe, the pressure in the pipe at the blower (4) and in the drain tank (7) is not equal. And the higher pressure area push the atomize mist and solution to the area with less pressure.

There are several ways to keep the pressure differentiate in the pipe. Appropriate methods include: 1. By reducing the pipe diameter. This eliminates the flow path by using pipe joints which different from the diameter of the pipe. This will make some of atomize mist and some of solution flow out of system. As a result, the other electrical components in the system are damaged by humidity. 2. By installing the open valve and close valve which change the direction current. 3. By installing the flux meter of the solution with pressure monitoring (Diaphragm type) which will lose pressure from the flux measurement sheet. 4. By bending pipe. The best way is to bend the pipe because it reduces the installation equipment and reduces its energy.

The bending of the pipe in the present invention is the special design pipe (6) with the above characteristics. The pressure inside the two pipes must be considered. The case is in the following table.

| To compare pressure at nearby pipe | Incident |
|---|---|
| Storage tank more higher than blower | Blower collapsed |
| Storage tank higher than blower | Blower collapsed |
| Storage tank equal to blower | Blower collapsed |
| Storage tank less than blower | Solution flow in the pipe |
| | through storage tank |
| Storage tank more less than blower | Solution and atomize mist flow out |

How to make a appropriate special design pipe (6) that is to set the pressure of the drain tank (7) less than the bowler in higher case and much smaller case. The implementation of a special design pipe (6) is to set the pressure of the drain tank (7) less than the pressure in the blower a little. To push the solution to the drain tank (7) by using a pipe like the letter U with unequal tail pipe. Its characteristic like the letter J and/or the letter J backward. The pipe at the blower is higher than the drain tank. If a pipe at blower is higher than the drain tank, the atomize mist and/or solution flow out to the growing chamber (5). If the position of the pipe at storage tank is higher than the blower, the solution will drain to the bending pipe and flow back to the blower. The blower will collapse eventually.

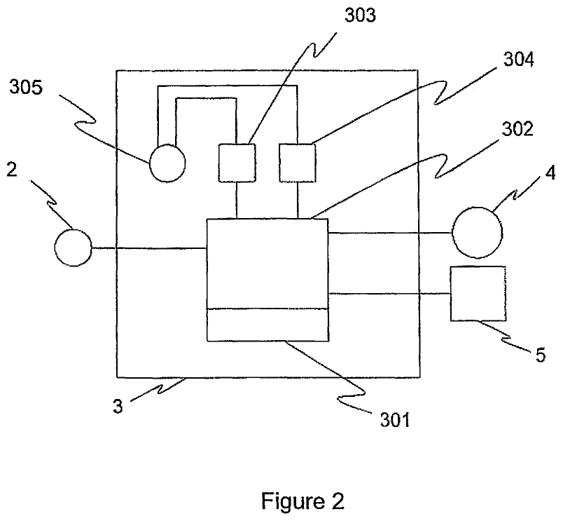

The system of the humidifier apparatus, the humidifier (3) as shown in FIG. 2. For some the pipe that carries the solution from the storage tank (1) flows through the pump (2) and to the humidifier (3) connected to the solenoid valve (305). Then the solution flows into the tank of humidifier (302) which store the solution with maximum and minimum scales for the volume of solution in the tank. When the solution enters the tank of humidifier (302), the humidity generator (301) works by evaporating the solution to evaporate to vapor or atomize mist that flows in a pipe connected to the blower (4)

The tank of humidifier (302) has a pipe that connected to the growing chamber (5). That is the blower for pulling the atomize mist to the growing chamber (5). And the path which has no blower is to carry the solution in the growing chamber (5) flow back to the tank of humidifier (302). When the solution in the tank of humidifier (302), up to the maximum value set, then the switch (303) acts to signal the solenoid valve (305) close. The solution from the storage tank (1) stop flowing. When the solution in the tank of humidifier (302) decreases to the minimum scale, the switch (304) activates the solenoid valve (305) to open causes the solution from the storage tank (1) into the tank of humidifier (302).

In addition, solenoid valves (305), switches (701) and (702) act as transmitters associated with the solution level according to the present invention. That can be replaced by any system such that sends a signal to control the volume of solution.

According to aspect of the present invention the humidifier cultivation and process are described as the humidifier for cultivation and process, that including of,

i. Special design pipe (6) with passage or path of the atomize mist and/or solution to the drain tank (7) and blower (4) which has for some a point such that look like crap and hole.

And/or,

ii. The system of humidifier apparatus comprising some closed path such that the way for the atomize mist and/or the solution and the closed path consist of at least 4 vertexes: the storage tank (1), the humidifier (3), the growing chamber (5) and the drain tank (7). The definition of closed path belongs to graph theory, mathematics.

Either i. or ii., or both. The humidifier apparatus has special characteristics that suitable for the process, comprising:

1. Special design pipe (6) has the suitable designations, that is, similar to the letters U, the letters J, the letters W and letter J backward. The most suitable designations that is similar to the letter J and the letter J backward.
2. Special design pipe (6) shall be considered for the pressure of the pipe in the vicinity of the blower (4) and the pipe near the drain tank (7). The suitable pressure is the pressure in the drain tank (7) is less than the pressure in the blower (4) area.
3. The special design pipe (6) will be connect the blower (4) to the position next to the blower (4), such that count from the atomize mist path from the humidifier (3) or the same area as the blower installation. And bring the atomize mist and/or solution that sticky the blower (4), the atomize mist and/or solution in the boundary to the pipe which has the special pipeline (6). The suitable area for connect the blower (4) is the position nearly the next blower (4).
4. The special design pipe (6) is also a component of the passage of the atomize mist and/or solution path between the drain tank (7) and the growing chamber (5).
5. The process of humidity for cultivation for some a closed path includes the storage tank (1), the humidifier (3), the growing chamber (5) and the drain tank (7). That can be add any devices to connected each path among the storage tank (1), the humidifier (3), the growing chamber (5) and the drain tank (7), whereas the atomize mist and/or solution can be passed and circulated close path.
6. The blower (4) acts to absorb the humidity from the humidifier (3) and blow the atomize mist into the pipe to the growing chamber (5). The suitable characteristic of the blower with pressure of is 1000 mmH2O to 10 mH2O where the blower fan has either waterproof or non waterproof. The most suitable characteristic of blower fan is the waterproof.
7. The characteristic of tank of humidifier (302) is strong, durability, resistant to the force of the blower (4), where the tank does not collapse or change shape, easy to clean and resistant to corrosion The suitable materials, is polyvinyl chloride, polyethylene, stainless steel 316L. The most suitable materials is stainless steel 316L.
8. The humidity generator (301) serves to change the state of the solution in the tank of humidifier (302) into the atomize mist. The suitable equipment is ultrasonic humidifier, ultrasonic head, which pays higher frequencies than sound frequencies. The solution can be evaporated to the atomize mist without heat. The optimum length of frequency is 0.5-8 MHz. The most optimum frequency is 1-7 MHz. The size of atomize mist size is 2-8 microns, which is the ideal size for growing plants. The optimum size of atomize mist for planting is 3-7 microns and the optimum size of atomize mist for mushroom and moss growing size is 2-8 microns.
9. The characteristic of pipe is path of the atomize mist and/or solution be easy to clean, resistant to corrosion and suitable for internal temperature. The suitable material is polyvinyl chloride, polyethylene, stainless steel 316L, stainless steel 304 and stainless steel 308. The most suitable material qualify as corrosion-resistant, lightweight, cheap, is polyvinyl chloride.
10. At the close path, for some 2 path of the atomize mist and/or solution such that connected the humidifier (3) and the growing chamber (5) whereas at least one path through the blower (4). At least 2 path or more in the closed path must be connected the humidifier (3) and the growing chamber (5) wherein at least one path through the blower (4).
11. Blower (4) can be integrated into the internal component of the humidifier (3).

Cultivation of plants in this invention includes moss mushroom as well.

The present invention includes the application to keep up the root cuttings and in the growing chamber (5), is the boundary of the present invention.

1. Humidifier cultivation and process comprising
i) Special design pipe (6) with passage or path of the atomize mist and/or solution flow to the drain tank (7) and blower (4) that has for some a point such that look like crap and hole,
And/or,
ii) The system of humidifier apparatus comprising some closed path such that path is the way for the atomize mist and/or the solution and the closed path consist of at least 4 vertexes: the storage tank (1), the humidifier (3), the growing chamber (5) and the drain tank (7), wherein the definition of closed path belongs to graph theory, mathematics.

2. Humidifier cultivation and process in accordance with claim 1 wherein the special design pipe (6) has the suitable designations the special design pipe is similar to the letters U, the letters J, the letters W and letter J backward.

3. Humidifier cultivation and process in accordance with claim 1 wherein the special design pipe (6) shall be considered for the pressure of the pipe in the vicinity of the blower (4) and the pipe near the drain tank (7), and the suitable pressure in the drain tank (7) is less than the pressure in the blower (4) area.

4. Humidifier cultivation and process in accordance with claim 1 wherein the pipe that has the special design pipe (6) will connect the blower (4) to the position next to the blower (4), such that count from the atomize mist path from the humidifier (3) or the same area as the blower installation, and bring the atomize mist and/or solution that stick the blower (4), the atomize mist and/or solution in the boundary to the pipe which has the special design pipe (6), and the suitable area for connect the blower (4) is the position nearly the blower (4).

5. Humidifier cultivation and process in accordance with claim 1 wherein the special design pipe (6) is also a component of the passage of the atomize mist and/or solution path between the drain tank (7) and the growing chamber (5).

6. Humidifier cultivation and process in accordance with claim 1 wherein for some a closed path such that a closed path includes the storage tank (1), the humidifier (3), the growing chamber (5) and the drain tank (7) that can add any devices to connected each path among the storage tank (1), the humidifier (3), the growing chamber (5) and the drain tank (7), whereas the atomize mist and/or solution can be passed and circulated close path.

7. Humidifier cultivation and process in accordance with claim 1 wherein the process of humidity for cultivation comprising, the solution in the storage tank (1) flows through the pump (2) to the humidifier (3) and the solution volatile to atomize mist and enter into the blower (4). The blower (4) sucks the atomize mist and blow it through the passage. In the invention the passage is two pipes, The first pipe is connected to the growing chamber (5). When the atomize mist gives the humidity in the growing chamber (5), the condensation of the atomize mist becomes solution, The solution flows through the pipe back into the humidifier (3) again, So the recycle of solution occur, The second pipe of the blower (4) is connected to the drain tank (7) through a special design pipe (6), The drain tank (7) act as the solution storage, When the solution and the atomize mist enter the drain tank (7), they accumulate to the required level, So the switch (701) and (702) transmit signal to drain the solution, the solution level in the drain tank (7) is the maximum level. The switch (701) sends the signal to the pump (703) which carry the solution in pipe through the storage tank (1) again, As resulting, the recycle of the atomize mist and the solution is recycled back, And when the solution level of the drain tank (7) decreases to the lowest level, the switch (702) will transmit the signal to the pump (703) to stop working.

8. Humidifier cultivation and process in accordance with claim 1 wherein the system of the humidifier apparatus comprising, for some the pipe such that carry the solution from the storage tank (1) through the pump (2) and to the humidifier (3) connected to the solenoid valve (305), Then the solution goes into the tank of the humidifier (302) that stores the solution with maximum and minimum scales for the volume of solution in the tank, When the solution enters the tank of humidifier (302), the humidity generator (301) works by evaporating the solution to the atomize mist that flows in a pipe connected to the blower (4) which installed outside the humidifier (3), The tank of humidifier (302) has a pipe that connected to the growing chamber (5), That is the blower for pulling the atomize mist to the growing chamber (5), and the path has no blower carries the solution in the growing chamber (5) flow back to the tank of humidifier (302), When the solution in the tank of humidifier (302), up to the maximum value set, then the switch (303) transmits signal to close the solenoid valve (305), The solution from the storage tank (1) stop flowing, When the solution in the tank of humidifier (302) decreases to the minimum scale, the switch (304) transmit a signal to open the solenoid valve (305) that causes the solution from the storage tank (1) to flow into the tank of humidifier (302).

9. Humidifier cultivation and process in accordance with claim 1 wherein the pressure of blower (4) is 1000 mmH2O to 10 mH2O where the blower fan has either waterproof or non waterproof.

10. Humidifier cultivation and process in accordance with claim 8 wherein characteristic of the tank of humidifier (302) is strong, durable, resistant to the force of the blower (4), where the tank does not collapse or change shape, easy to clean, resistant to corrosion The suitable materials are, polyvinyl chloride, polyethylene, and stainless steel 316L.

11. Humidifier cultivation and process in accordance with claim 8 wherein the humidity generator (301) serves to change the state of the solution in the tank of humidifier (302) into the atomize mist, The suitable equipment is ultrasonic humidifier, or ultrasonic head.

12. Humidifier cultivation and process in accordance with claim 11 wherein the humidity generator (301) has the optimum length of frequency is 0.5-8 MHz. The optimum length of the atomize mist size is 2-8 microns.

13. Humidifier cultivation and process in accordance with claim 1 wherein path or pipe is a passage of cough, The characteristics of atomize mist and/or solution is easy to clean, resistant to corrosion suitable for internal temperature, The suitable material is polyvinyl chloride, polyethylene, stainless steel 316L, stainless steel 304 and stainless steel 308.

14. Humidifier cultivation and process in accordance with claim 1 wherein at the close path, for some 2 path of the atomize mist and/or solution such that connected the humidifier (3) and the growing chamber (5) whereas at least one path through the blower (4), Or say that is at least 2 path or more in the closed path must be connected the humidifier (3) and the growing chamber (5) wherein at least one path through the blower (4).

15. Humidifier cultivation and process in accordance with claim 1 wherein the growing chamber (5) has a cavity with entrance of atomize mist and/or solution at least one passage and has plants or roots or both of them.

16. Humidifier cultivation and process in accordance with claim 15 wherein the plants according to this invention includes moss, mushroom and the root cutting.

17. Humidifier cultivation and process in accordance with claim 1 wherein the suitable method to keep the pressure in the special design pipe (6): 1, To reduce the pipe diameter. 2, By installing the open valve and close valve which change the direction current. 3, By installing the flux meter of the solution with pressure monitoring (Diaphragm type) which will lose pressure from the flux measurement sheet, 4, By bending pipe.

18. Humidifier cultivation and process in accordance with claim 1 wherein the special design pipe (6) has the suitable designations, that is, similar to the letters U, the letters J, the letters W and letter J backward.

19. Humidifier cultivation and process in accordance with claim 7 wherein the solenoid valves (305), switches (701) and (702) act as transmitters associated with the solution level according to the present invention, Can be replaced by any system such that sends a signal to control the volume of solution.

20. Humidifier cultivation and process in accordance with claim 1 wherein the blower (4) can be integrated into the internal component of the humidifier (3).
